(19) United States
(12) Patent Application Publication
(10) Pub. No.: US 2009/0324838 A1
(43) Pub. Date: Dec. 31, 2009

(54) Methods of Manufacturing Structural Reinforcement Materials

(76) Inventor: Mark W. Jolley, Carlsbad, CA (US)

Correspondence Address: FITCH EVEN TABIN & FLANNERY, 120 SOUTH LASALLE STREET, SUITE 1600, CHICAGO, IL, 60603-3406, US

(21) Appl. No.: 12/393,744

(22) Filed: Feb. 26, 2009

Related U.S. Application Data
(60) Provisional application No. 61/031,597, filed on Feb. 26, 2008.

(51) Int. Cl. B05D 1/02; B05D 1/36

(52) U.S. Cl. 427/412.1; 427/427.6

(57) ABSTRACT

Methods of manufacturing sport and other boards and devices are disclosed that include providing a foam core, such as expanded polystyrene or polyurethane. The foam core may be pre-shaped into the desired shape for the user or group of users. The method further includes the step of spraying a polyurethane reinforcing skin around the core to substantially encapsulate the core in the skin, and thus provide a board having a rigid outer skin. The methods may also include adjusting the thickness in at least one predetermined area in order to modify the flexibility of the board in the at least one predetermined area as compared to adjacent portions of the board.

### CROSS-REFERENCE

This application claims priority to U.S. Provisional Patent Application Ser. No. 61/031,597, filed Feb. 26, 2008, which is hereby incorporated by reference in its entirety.

### FIELD

The methods described herein relate generally to reinforcing and the production and manufacturing of sport and other products currently using fiberglass as its primary means of reinforcement such as boards, and in particular to

### BACKGROUND

Surfboards and other types of products can commonly be fabricated from Fiberglass Reinforced Plastic (FRP) and may include a core to provide rigidly. Examples include the manufacturing of a boat, jet ski, surfboard, and the like where current manufacturing methods use molds, fiberglass and/or plastic to form the product. Current manufacturing methods, however, emit high amount of VOCs (Volatile Organic Compounds) into the atmosphere. FRP products are formed by employing fiberglass to reinforce a polyester based resin that has been cured via a catalyst. This polyester-based resin can be infused, sprayed, vacuum bagged, or hand applied.

Many products are formed in such a manner using FRP. Examples include, but are not limited to, watercraft, Jet skis, sport boards, snowmobiles, motorcycles, four wheelers, dirt bikes, airplanes, unmanned aircraft, spacecraft and other flying machines, bath tubs, showers sinks, ceiling and walls, forms, domes, doorways, facades, fountains, gateways hoods, pavilions pedestals, garage doors, fencing windows, even complete prefabricated houses. FRP has also been used for decorative items for exhibits, museums exhibits, display reproductions, or simulations that can be molded and formed over and over. Industrial reinforcing of pipes, tanks, enclosures, consoles buildings military applications, odor and acid control systems, flumes forms poles etc. Agricultural applications have also used FRP, such as harvest containers aquaculture tanks, and grain storage silos to name but a few items within this category. Automotive applications may use FRP in many parts currently manufactured with steel and or plastic. Other items such as bumpers, hoods, doors, fenders, beds, and tops, many parts of the racing industry (such as spoilers and cowlings, fenders and fire resistant lightweight panels) may also be FRP.

All the current fiberglass reinforced products generally have one common shortcoming in that VOCs are released during their manufacture. In some cases, the VOCs contain styrene monomers and methyl ethyl ketone which may be a health hazard and, in some cases pose a risk of chronic health effects from either long term or short term exposure to such VOCs. Prior methods of manufacturing fiberglass reinforced products have likely done damage to both the environment and the people that have had and continue to have daily contact to this material. During manufacture of the FRP, the curing reaction with the resin based material (such as polyester or epoxy) generally results in the high level of output of VOCs.

Surfboards are made from a variety of materials using different methods. Initially, surfboards were made by hand carving wood boards. Another way of manufacturing a surfboard involves the use of foam reinforced with fiberglass. Both wood and foam and fiberglass surfboards have durability problems. Another type of surfboard was developed using an epoxy and PVC with an EPS (expanded Polystyrene) core foam sandwiched between fiberglass matting. Although more durable and lighter than wood or foam reinforced fiberglass boards, such boards still have durability problems along with intensive and costly labor necessary to manufacture the boards. The fiberglass industry is very labor intensive and with the rise of oil prices the cost per pound has dramatically increased.

In the example of a surfboard, most surfboards are currently made using urethane foam with a fiberglass outer matting, a technology that is about sixty years old. Manufacturing such a foam surfboard having fiberglass matting involves multiple steps. The first step is to purchase a foam blank. The blank is a large piece of foam, such as urethane, that has yet to be cut to the precise dimensions of the surfboard. There are a variety of different types of blanks for use and manufacturing different types of surfboards. For example, there are blanks for short and long surfboards. These substructures or blanks have evolved and can also be made from expanded polystyrene (EPS). They can now also be formed in a mold to the final desired shaped and or shaped.

The next step is to cut the blank down to the desired shape or shape the board. This task involves selecting a template and attaching the template to the blank. The template is a standardized design according to the particular desirability of the surfboard parameters, such as the weight, shape, and width which contribute to the overall balance and feel of the surfboard. The blank is routed or cut with a saw and shaped by hand to correspond to the perimeter of the template. The blank must also be planed to the appropriate thickness. The rails of the surfboard must also be foiled. The surfboard blank is then hand sanded and-shaped into the finished design shape. The blanks may also be sent to a CNC machine where it is cut, in some cases, to within millimeters of the finished product which is than hand sanded to the desired shaped. Most recently, some manufacturers have began molding the blank in an EPS injection machine to the desired finished product and then lightly sanded before continuing to the next step.

Once the surfboard blank has been converted into the appropriate form, multiple finishing steps must be performed. One of the first finishing steps is to remove a portion of the blank corresponding to a fin box. A fin box includes attachment means for attaching fins relative to the fin box which in turn is attached to the surfboard. A leash plug is also inserted into the foam board. The leash plug allows for the attachment of a surfboard leash, which is used to tether the surfboard to a rider. Graphics and other artwork may be applied to the foam board.

Fiberglass matting or fiberglass weave is then applied around the entire surfboard. The fiberglass is applied in multiple layers, typically by hand. Each fiberglass layer is coated with a catalyzed epoxy or polyester based resin, which may create an excessive emission of VOCs. In some cases, the VOCs can be captured and burned or “scrubbed” before entering the atmosphere, but in other cases these emissions are simply allowed to be vented to the outside air.

Each layer is allowed to dry before the next layer is applied. This adds considerable time to the process, which can take between three and five days. Not only does it add time, but it is a fairly labor intensive process of repeatedly applying the fiberglass layers. Due to the manual application, inconsistencies in thickness can inadvertently result, negatively impacting the finished properties of the board. Resin is applied over the fiberglass matting and cured using hot coating techniques. After curing, the resin coated board is sanded to remove any ridges or bumps. In all the products described herein, the multiple layers of the fiberglass and resin layers are required to give the product the desired strength. During application, each layer may emit VOCs.

After the surfboard has been coated with fiberglass, striping and other exterior artwork may be applied. The surfboard is typically prepared for a gloss coat of resin (generally emitting additional VOCs). The gloss coat must be allowed to cure prior to hand polishing. Lastly, the surfboard must be cleaned to remove any dust resulting from polishing of the gloss coat.

Many of the typical steps described above require skilled technicians adding to the increased cost of labor, resulting in a costly product. A typical surfboard made using the above process will take up to ninety-six hours, including drying and curing time. Moreover, many of the functions involve subjective shaping decisions and techniques, which can result in non-uniform surfboards, even when made using identical templates.

In addition, the traditional application of fiberglass can be a toxic process and can cause harm to both the environment and those applying the fiberglass. In more recent years, prior cores made of a TDI (Tolune Diisocyanate)-based polyurethane foam have been replaced with cores of an MDI (methylene diphenyl diisocyanate) polyurethane, which can reduce health risks associated with forming and shaping the cores, but this generally has been used in surfboard manufacture and, in such instance, only to the core with the rest of the product still made with materials emitting VOCs.

### SUMMARY

Alternative methods of manufacturing products currently made using fiberglass or FRP methods for structural reinforcement including, but not limited to, sport and other boards are provided, where the prior step of applying multiple layers of fiberglass to a core is replaced with a more efficient step of applying a skin or outer layer of a comparatively fast-curing material. The material is initially in a generally fluid state to allow for it to be applied using spraying techniques, but also comparatively rapidly solidifies to form a rigid exterior skin to the core. Alternatively, in the case of other products, such as a car bumper, the material could be applied directly over the in-mold coating to for the finished part. The use of such a material, such as a polyurethane, is an improvement over the prior art techniques of applying fiberglass to the core, and makes it possible to greatly reduce the amount of labor, materials and time to produce the board or any type of product discussed, but for purpose of brevity we will focus on a surfboard. The methods and materials herein also reduce the amount of VOC emissions to essentially zero. The composite structure will demonstrate similar properties to that of an FRP constructed article; for example, in the case of a surfboard, a structure produced as described herein can exhibit a flexural modulus of at least 180,000 lb/in2.

In addition to improving the manufacturing process, other benefits result from the use of such a material for an outer layer of the board. This material can result in a board that is lighter and can perform better than those manufactured using traditional technologies. Notably, the methods disclosed herein permit the core to be formed using traditional techniques, which can include shaping by hand, CNC shaped or injection molded EPS. This allows for the flexibility of providing a custom-shaped board for the individual user to be maintained, but with the addition of a more cost-effective, durable and improved outer layer or layers.

In some cases, the skin or outer layer will include multiple layers. A first layer can be essentially free from VOCs and preferably contain an aliphatic component, which is stable to ultraviolet light. In yet other cases, such as with the surf board, this first layer or aliphatic layer could be the outer most layer and be applied after (not before) the reinforcing layer.

In one aspect, the reinforcing and/or the outer layer of material can be applied or sprayed using automated equipment. Not only does this permit even more efficient manufacturing, but the consistency of the thickness of the outer layer can be more uniform, resulting in a board and/or other product with performance properties, such as flexion, that are more predictable and more repeatable as compared to traditional manufacturing methods using multiple fiberglass layers as an outer or inner skin. Using automated machinery to apply the outer layer of material can also provide for the ability to modify the thickness in predetermined areas, as compared to the thickness of adjacent areas, in order to intentionally modify the performance properties of the board in specific ways. For instance, the increased thickness in certain areas can result in more rigidity in those areas, which can be desirable for certain users of the boards. This adds another layer of custom-ability that is not previously available in such a controlled manner.

In one aspect, the outer layer (or layer in which an aliphatic property is desired) is formed through a reaction between a polyisocyanate component that includes an aliphatic polyisocyanate and a resin component including a polyamine to form the first of one or more layers to provide the properties desired to achieve the specifications of the finished product. The hardness of said layer is important to the overall construction of the finished part and can be modified but generally achieves a shore A hardness of at least about 67. Prior products made from fiberglass and other such materials can be durable, but have been prone to cracking under certain circumstances. As a result, the methods provided herein generally provide the same durability but with greater hardness properties to absorb an impact, which resists cracking, as measured with the falling dart test.

In other aspects, the inner layer (or the layer that provides the physical properties) generally has a minimum flexural modulus of at least about 180,000 lb/in2 and is similar to the outer layer where it is a composite material that creates relatively high strength with very low VOCs. This composite consists of a polyisocyanate component and a resin based component. In some cases, the resin component includes a minimum of one Polyol with the functionality of at least three. In other cases, the Polyol includes a plurality of polyols with at least a polyether component made from an available initiator compound having three functional groups. One that contains a hydroxyl number of about 200 meq Polyol/g KOH or more, and a viscosity of less than about 5,000 centipoise or less at 70 F. The inner and outer layers combine to make a structure that has superior properties than that of the replaced structure.

A method is also presented wherein an additional flexible layer may or may not be applied in a similar manner using similar materials that would increase the flexibility of the finished product. More specifically a layer that has a shore A hardness of about 67 (substantially softer and more flexible) but inserted between the two layers to act as a shock absorber to the initial impact of the flying dart. Thereby having the ability to absorb a greater impact than that of the inner and outer layers only.

In the representation of the surfboard, the board preferably will include a core covered with the inner layer for strength than the outer layer for UV stability. In one aspect, the methods may include providing a foam core, such as expanded polystyrene or polyurethane. The foam core may be pre-shaped into the desired shape for the user or group of users. The method further includes the step of spraying a polyurethane reinforcing skin around the core to substantially encapsulate the core in the skin, and thus provide a board or product, having a rigid outer skin.

In another aspect, the methods may include manufacturing a board or other product having at least one area of modified flexibility as compared to adjacent portions of the product. The method includes providing a core formed from one of an expanded polystyrene or polyurethane and spraying a plurality of layers of diphenyl diisocyanate based high density polyurethane using a computer controlled spray gun directly onto the core to form a skin substantially encapsulate the core. The thickness of the skin is adjusted in at least one predetermined area in order to modify the flexibility of the board in the at least one predetermined area as compared to adjacent portions of the board.

The methods for manufacturing described herein are applicable to a wide variety of products previously made using FRP. Examples include, but are not limited to, surfboards or other sport boards, such as water skis, snowboards, skateboards, knee boards, kite surfing boards, body boards, wake boards, skim boards, kayaks, paddle boards, and wind surfing boards. The methods can also be used to produce other devices, and in particular devices requiring flexion and structure combined with light weight used in recreational manners to surf, ski or float on water, snow or other surfaces. Other examples include watercrafts (such as boats, both power and sail, kayaks, canoes and many other configurations), jet skis, sport boards (such as but not limited to Surf, skate body and skim), snowmobiles, motorcycles, four wheelers, dirt bikes, airplanes, unmanned aircraft, spacecraft and other flying vehicles, bath tubs, showers sinks, ceiling, walls, forms, domes, doorways, facades, fountains, gateways hoods, pavilions pedestals, garage doors, fencing windows, prefabricated houses, decorative items, museums exhibits, displays reproductions, industrial reinforced pipes, tanks, enclosures, consoles buildings military applications, odor and acid control systems, flumes, poles, harvest containers aquaculture tanks, grain storage silos, automotive components. Other things such as bumpers, hoods, doors, fenders, beds, and tops, many parts of the racing industry such as spoilers and cowlings, fenders and fire resistant lightweight panels. The methods provided herein provide for a manufacturing method wherein most if not all of the products discussed can be replaced with a product containing virtually no VOCs at all. While the methods are hereinafter described with respect to a surfboard, the methods and formulas could also be applied to any of the aforementioned industries and applications.

### BRIEF DESCRIPTION OF THE DRAWINGS

FIG. 1 is a diagrammatic view of layers of a board, moving outwardly from the inner portion of the board;

FIG. 2 is a partial perspective view of a surfboard showing the inner and outer layers thereof;

FIG. 3 is an illustrative perspective view of the surfboard of FIG. 2 showing the application of the outer layer;

FIG. 4 is an illustrative perspective view of an alternative surfboard showing the application of the outer layer with increased thickness adjacent the side rails;

FIG. 5 is an illustrative perspective view of an alternative surfboard showing the application of the outer layer with increased thickness adjacent the tail;

FIG. 6 is a partial perspective view of a surfboard similar to that of FIG. 2, but having transverse and longitudinal reinforcing rods formed in the core;

FIG. 7 is a partial perspective view of a surfboard similar to that of FIG. 2, but having longitudinal and parallel reinforcing plates formed in the core;

FIG. 8 is a partial perspective view of a surfboard similar to that of FIG. 2, but having longitudinal and perpendicular reinforcing plates formed in the core;

FIG. 9 is a partial perspective view of a surfboard similar to that of FIG. 8, but having differently-placed longitudinal and perpendicular reinforcing plate formed in the core;

FIG. 10 is a front elevation view of a core for use in forming a board, and showing reinforcing members added to the exterior of the core;

FIG. 11 is a front elevation view of a finished surfboard made according to the methods described herein; and

FIG. 12 is another diagrammatic view of layers of a board, moving outwardly from the inner portion of the board.

### DETAILED DESCRIPTION OF EXEMPLARY EMBODIMENTS

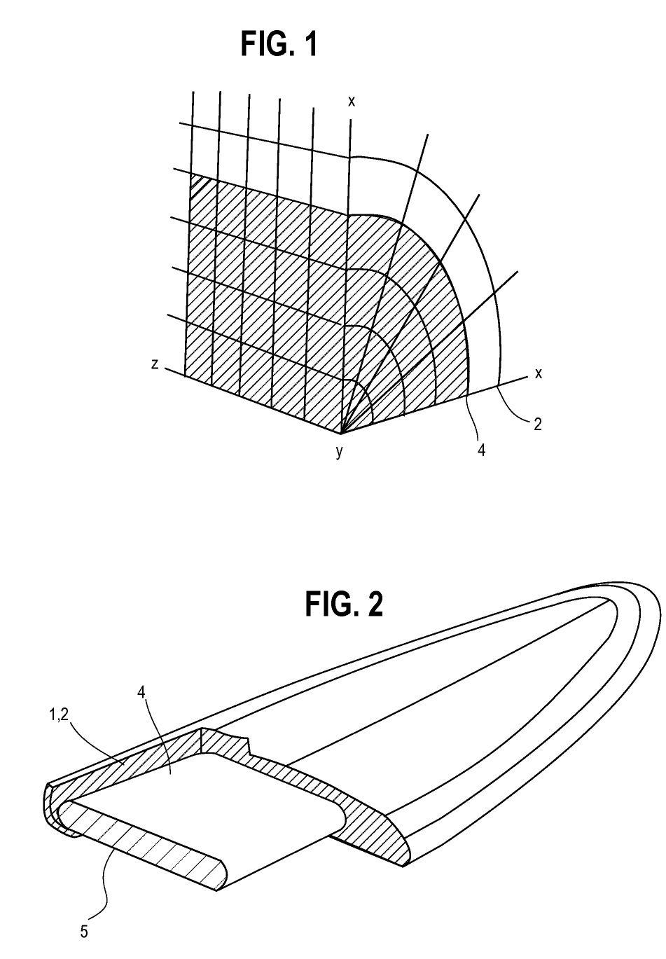

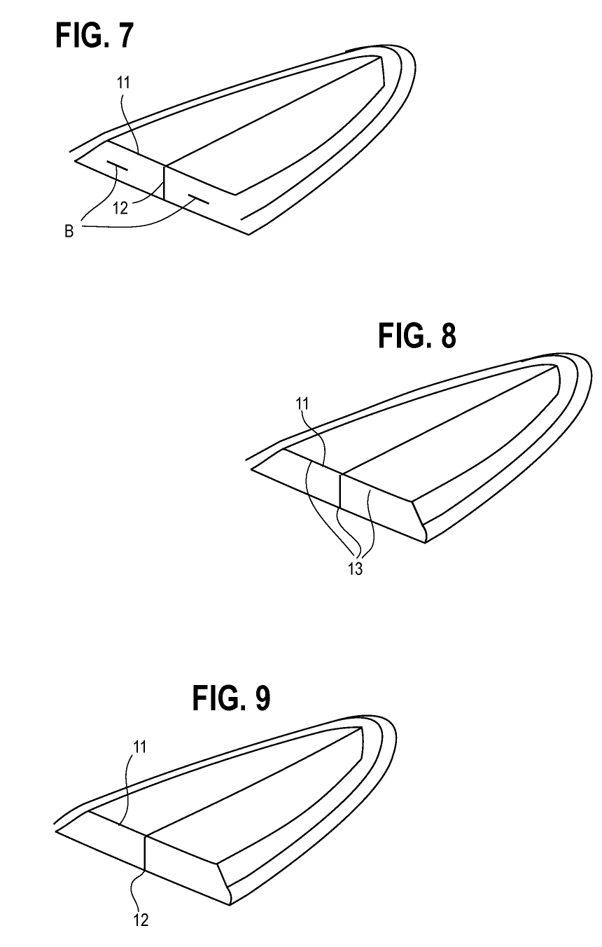

Methods of manufacturing products currently made using fiberglass or FRP methods for structural reinforcement include but are not limited to sport and other boards are provided. Various structures of the products of which are depicted in FIGS. 1-12, where the prior step of applying multiple layers of fiberglass to a core is replaced with a more efficient step of applying a skin or outer layer of a comparatively fast-curing material. In particular, the methods may include providing a foam core, such as expanded polystyrene or polyurethane. The foam core may be pre-shaped into the desired shape for the user or group of users. The method further includes the step of spraying a polyurethane reinforcing skin around the core to substantially encapsulate the core in the skin, and thus provide a board having a rigid outer skin. More specifically the outer layer or layer in which and aliphatic property is desired there is a reaction between chemicals of a polyisocyanate component that includes one of many aliphatic polyisocyanate available on the market and a resin component including a polyamine which react with the polyisocyanate to form the first of one or more layers to provide the properties desired to achieve the specifications of the finished product. The hardness of said layer is important to the overall construction of the finished part and can be modified but generally achieves a shore A hardness of at least 67. This is important dure to all the prior products made from fiberglass and other such materials as they are durable but have been prone to cracking under certain circumstances. The method provided herein creates the same durable part but with greater properties to absorb an impact to resist cracking and can be easily measured using a common test of the falling dart.

In one aspect, the inner layer or the layer that provides the physical properties has a minimum flexural modulus of at least about 180,000 lb/in2 and can be similar as the outer layer where it is a composite material that creates increased strength with low VOCs. By one approach, this composite includes a polyisocyanate component and a resin based component; in one case, a resin component that has a minimum of one Polyol with the functionality of at least three. In other aspects, but not limited to, a Polyol where the there is a plurality of polyols including at least a polyether made from an available initiator compound having three functional groups. One that contains a hydroxyl number of about 200 meq Polyol/g KOH or more, and a viscosity of less than about 5,000 centipoise or less at 70 F. The inner and outer layers combine to make a structure that has superior properties than that of the replaced structure.

A method is also presented wherein an additional flexible layer may or may not be applied in a similar manner using similar materials that would increase the flexibility of the finished product. By one approach, a layer that has a shore A hardness of about 67 (substantially softer and more flexible) but inserted between the two layers to act as a shock absorber to the initial impact of the flying dart. Thereby having the ability to absorb a greater impact than that of the inner and outer layers only.

The methods may also include adjusting the thickness in at least one predetermined area in order to modify the flexibility of the board in the at least one predetermined area as compared to adjacent portions of the board.

The manufacturing methods begin with provision of a core. The core can be formed of an expanded polyurethane, such as an MDI polyurethane. The core can be shaped, whether by hand, molding, machine or combinations thereof, into the desired shape. The core can then be prepared, such as including cleaning, to prepare it for application of the outer reinforcing layer or skin. The encapsulating skin provides the structural rigidity to the board, while also protecting the core to a large degree from damage.

The manufacturing method may also begin without a core wherein the process hereto described is reversed where the outer layer comes into contact with a mold made in typical mold making processes. The mold would then be coated with a mold release agent. Then, the outer skin would be applied followed by the inner layer. This method could also contain the sandwich of the softer material if the product requirements dictate a greater need for impact resistance.

With reference to FIG. 2, the core 5 is at the innermost part of the surfboard. The skin 4 is outwardly thereof, as also shown in FIG. 2. Other cosmetic and protective layers can also be applied outwardly of the skin 4. More specifically skin 4 or the inner layer can be further defined as a composition. In one aspect, the inner layer or the layer that provides the physical properties may have a minimum flexural modulus of at least about 180,000 lb/in2 and is described such as the outer layer where it is a composite material that creates high strength with low VOCs. This composite may include a polyisocyanate component and a resin based component, in this case a resin component that has a minimum of one Polyol with the functionality of at least three. In one approach, but not limited to, a Polyol where the there is a plurality of polyols including at least a polyether made from a available initiator compound having three functional groups is utilized. In another approach, one that contains a hydroxyl number of about 200 meq Polyol/g KOH or more, and a viscosity of less than about 5,000 centipoise or less at 70 F. The inner skin may be composed of a specific group of chemicals that when combined emit essentially no VOCs.

The cosmetic layer 2 may be a water-born paint or marine grade finish, a white coat of poly urea, an airbrushed artistic or digitally created graphics. A protective outermost layer 1, such as a clear coat water based paint, varnish, lacquer or hot coat of epoxy resin finishes the surfboard. A primer layer 3 can be applied between the skin and the other outer layers. This may not be necessary, but can be useful if the other layers are not applied shortly after formation of the skin, such as if the skin is left for four to eight hours. If there is no substantial delay between formation of the skin and application of the cosmetic layers, then the components can potentially bind on a molecular level, eliminating the need for the primer layer 3. Examples of the order of these layers outwardly from the core are depicted in FIGS. 1 and 12.

The skin 4 is a critical component of the finished product, and thus the methods disclosed herein. The skin is preferably a blend of the following chemicals:

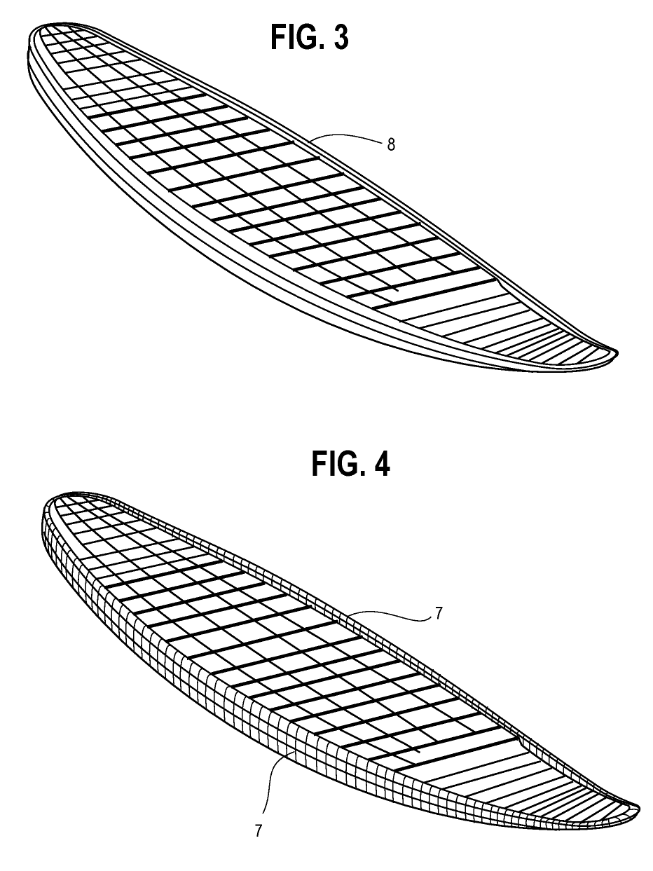

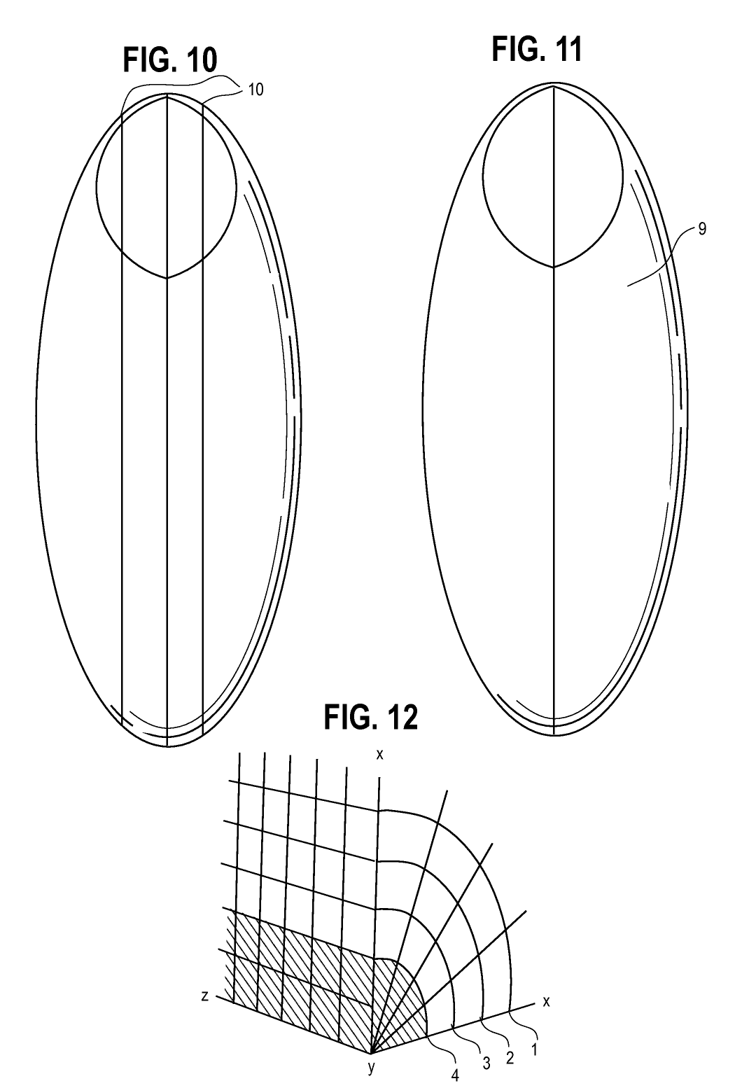

An Isocyanate is part B in the composition would generally include but not be limited to approximately about 50% (a polymeric Diphenylmethane diisocyanate (PMDI)) this may or may not be partially reacted (which is commonly referred to as pre-polymerization) to make it more compatible with its co-component in the inner layer which consists of generally and may or may not contain approximately about 52% of a polyether having a hydroxyl number of about or around 200 and an average functionality of about 3. It may or may not also contain approximately 10% of a filler. It may or may not contain a crosslinking additive or agent A of approximately 9% which may or may not be (diethylene glycol). Also a reactive dilutent A of approximately 10% may be included. It may also contain approximately 19% Polyol B. This is an approximation of one exemplary configuration of MDI-based polyurethanes that give the apparatus structural strength, and ties together the core and any external 10 or internal reinforcing structure, as illustrated in FIGS. 3 and 10, to produce a finished product, such as illustrated in FIG. 11. The skin has the ability to bond to the core material or materials, including the reinforcing structure materials. The material for the skin is preferably able to be sprayed on the core 5 in a fluid state, such as using automated machinery, which can be a Graco high pressure machine using a spray gun that mixes the blend upstream of the gun. Once on the core 5, the skin 4 hardens to form the rigid, encapsulating shell that protects and provides rigidity to the core 5. Without the core in the case of a bumper or fender the skin 4 can be increased from about 4 mils thick to over about 6000 mils thick to achieve the desired strength to weight ratio. By one approach, these material can be mixed anywhere from about a 1 to 3 ratio of part 1 and 2 or about a 3 to 1 ratio based on the desired outcome and material properties desired for the finished product. Ideally they would run on a 1 to 1 ratio between about 2000 and about 4000 psi.

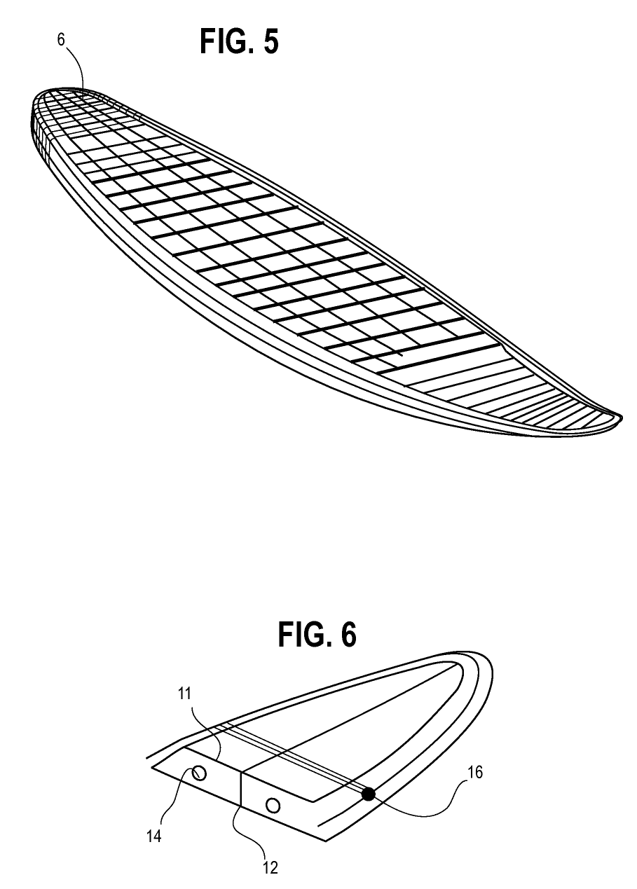

The application of the skin 4 using automated machinery advantageously can permit for very precise thickness control in order to produce a surfboard having generally uniform flexion properties. However, the thicknesses can be varied in predetermined areas, such as any of the areas of FIG. 3, as compared to adjacent areas, to selectively modify the flexion properties of the board to achieve desirable performance properties. The spray rate can be adjusted, such as by changing the size of a spray orifice on a spray gun, to vary the thickness of the skin 4. For example, the skin 4 can be increased in the tail, as illustrated in FIG. 5, to provide a stiff tail that resists flexing to permit for a sharper turn at the bottom of a wave when surfing. In another example, the outer edges or rails 7 can have an increased thickness in order to permit the rails to “dig” into a wave when surfing, as illustrated in FIG. 4. The regions of increased thickness can also be applied to areas where greater damage is likely, such as edges of snowboards or skateboards, to reduce the potential for such damage.

In addition to using the thickness of the skin 4 to control the flexion and other structural and/or performance properties of the board, such as rigidity, spring or the like, other structure such as stringers in the core can be utilized, examples of which are depicted in FIGS. 6-9. These can include various types of transverse and longitudinal reinforcements 11-14 and 16. The reinforcement materials can be formed, for example, of wood, plastic, carbon fiber or other materials, and may be glued or inserted into the core 5.

Turning to examples of the methods, the core 5 is first provided in its preformed shape ready for application of the skin 4. Stringers or other structural or protective elements, such as those depicted in FIGS. 6-9, can then be added. Fins, leash attachments, bindings, or the like can be attached to the core. After cleaning, the core may optionally be put into a chamber to raise its temperature to around 80° F. to assist in adhesion of the skin.

Next, the skin is sprayed using a high pressure, temperature controlled machine, such as the above-mentioned Graco machine. The material may also be applied by hand spraying. When a machine is used, the size of the spray gun orifice can be adjusted to control the thickness of the skin in predetermined areas, as discussed in greater detail above. Incorporating robotics into the spaying process, through computer controlled spraying, can achieve a higher level of control than can be achieved under standard conditions.

Other factors play a major role in the ability to produce consistent products can include controlling the temperature of the raw materials to optimize their usage and shelf life. The ideal range would be between 70 and 100 degrees F. One can also control the ratio of materials coming through the gun which may or may not be the same based on the specific application. For example a snowboard manufactured in this method would require a different ratio of material than a surf board, but generally the ratio between the Isocyonate and the Resin is at one to one. This can optimize the equipment and make for easier application. The temperature of the chemical flowing through the machine also can be regulated to control how the two chemicals react to each other, such as in one example at an optimal range would be between 110 F and 160 F. The hose temperature of the spray gun would be set to a similar range to maintain consistent flow and ratio control as the two different material have a different viscosity ranges. The gun would be specified to the particular application of the material for example in the case of the surfboard we would us a Graco Fusion Gun or other similar equipment with a wide aspect ratio tip to coat the core evenly and homogeneously at the same time. In the process the pressure of the materials coming out the gun can be within the range of 2000 psi to 3000 psi based on the application. Having this level of control allows the manufacture to obtain the desired performance of the designer and does it in a method that reduces or eliminates harm the environment.

After the part has received this coating which ties into the substructure to complete an encapsulation of the core material to create an incredibly high strength to weight ratio and allowing for endless combinations to create different flex patters critical to the overall performance of the product the part is allowed to cure. Due to the superior properties designed into the chemical formulation this occurs within two to five minutes again based on the application as the snow board would require additional material and need to cool a few more minutes than say a body or surf board. This in stark contrast to the many hours if not days required in the current methods of manufacturing these products.

The next step depending on the product would be the preparation for the final cosmetic coat or top coat to the apparatus. In the case of the surf board the fin boxes that hold the fins in the desired location would have to be sanded down to become flush with the skin. Or any such apparatus such as the screw inserts of a snowboard or leash plug of a body board. The apparatus may or may not require sanding at this time. In most applications no additional sanding of the part would be necessary.

If applied within a given period of time for example 4 hours of removing the part from the skin application no primer based coating is needed as the high density urethane is still open on the microscopic level and the top coat will fill into and attach itself to those open pours. If desired the part may sit indefinitely and simply have a water based primer applied prior to the top coat, after the pours have closed. Because of the formulation of the chemicals no other preparation is needed before the cosmetic coat.

The cosmetic coat may consist of any exterior water based product which may or may not be limited to any and all automotive finishes available again through Basf or other type chemical companies. The cosmetic coating is limited only by the designers' imagination as the product will accept any paint or finish in addition to digitally created and sublimated images which give a digital image to the surface. This allows for such things as the end user designing his own graphics which than can be sent via the web to the manufacturer printed on an Epson sublimation process than applied to the finished product with the application of heat. It can also be airbrushed with water based marine grade finishes to give the part any type finish that is imaginable.

At this point the product can be finished with whatever exterior attachments have been designed and incorporated and shipped as a very durable low cost high performance product that far exceeds what is currently available on the market place today made using traditional methods.

As can be appreciated from the above description of FIGS. 1-12, there is provided a new improved method for manufacturing a board. While the above description references use of the methods for producing a surfboard, the methods described herein are applicable to other devices and are not limited to surfboards, or even to floatable boards. While there have been illustrated and described particular embodiments, it will be appreciated that numerous changes and modifications will occur to those skilled in the art, and it is intended in the appended claims to cover all those changes and modifications which fall within the true spirit and scope thereof.

1. A method of manufacturing a board, the method comprising:
providing a core formed from one of an expanded polystyrene or polyurethane; and
spraying a polyurethane reinforcing skin around the core to substantially encapsulate the core in the skin.

2. The method of claim 1, wherein the skin is a methylene diphenyl diisocyanate based high density polyurethane.

3. The method of claim 2, further including the step of raising the temperature of the core to about 80° F. prior to the step of spraying the polyurethane skin.

4. The method of claim 1, wherein the step of spraying the polyurethane skin further includes using a high pressure automated machine for the spraying.

5. The method of claim 4, further including the step of attaching at least one stringer to the core prior to the step of spraying the polyurethane skin.

6. The method of claim 4, wherein the step of providing a core includes the step of inserting at least one stringer during formation of the core.

7. The method of claim 4, wherein the step of spraying the polyurethane skin further includes the step of varying the thickness of the skin in at least one predetermined area in order to modify the flex properties of the board as compared to a board having a skin of uniform thickness.

8. The method of claim 7, wherein the step of varying the thickness of the skin in at least one predetermined area includes reducing the thickness of the skin covering a tail of the board as compared to adjacent areas of the board in order to provide a board having a more flexible tail.

9. The method of claim 7, wherein the step of varying the thickness of the skin, in at least one predetermined area includes increasing the thickness of the skin covering a tail of the board as compared to adjacent areas of the board in order to provide a board having a more stiff tail.

10. The method of claim 7, wherein the step of varying the thickness of the skin in at least one predetermined area includes increasing the thickness of the skin adjacent outer longitudinal edges of the core to provide a board having stiffer rails.

11. The method of claim 7, wherein the step of varying the thickness of the skin in at least one predetermined area includes controlling the amount of skin material exiting an orifice of the machine by adjusting the size of the orifice.

12. The method of claim 11, wherein the skin is formed from at least two different materials having different viscosities that are mixed in the machine prior to exiting the orifice, the method further including the step of separately controlling the flow rates of the two different materials upstream of the orifice.

13. The method of claim 4, wherein the step of spraying a polyurethane reinforcing skin using the machine further includes pressurizing material forming the skin to between 2000 psi and 3000 psi prior to exiting the machine.

14. The method of claim 1, wherein the step of spraying the polyurethane reinforcing skin around the core further includes the step of directly applying the polyurethane reinforcing skin to the core.

15. The method of claim 14, further including the steps of:
spraying a primer layer on the reinforcing skin;
applying a paint on the primer layer; and
applying a clear coat on the paint layer.

16. A method of manufacturing a board having at least one area of modified flexibility as compared to adjacent portions of the board, the method comprising:
providing a core formed from one of an expanded polystyrene or polyurethane;
spraying a plurality of layers of diphenyl diisocyanate based high density polyurethane using a computer controlled spray gun directly onto the core to form a skin substantially encapsulate the core; and
adjusting the thickness of the skin in at least one predetermined area in order to modify the flexibility of the board in the at least one predetermined area as compared to adjacent portions of the board.

17. The method of claim 16, wherein the wherein the step of adjusting the thickness of the skin in the at least one predetermined area includes reducing the thickness of the skin covering a tail of the board as compared to adjacent areas of the board in order to provide a board having a more flexible tail.

18. The method of claim 16, wherein the wherein the step of adjusting the thickness of the skin in the at least one predetermined area includes increasing the thickness of the skin covering a tail of the board as compared to adjacent areas of the board in order to provide a board having a more stiff tail.

19. The method of claim 16, wherein the wherein the step of adjusting the thickness of the skin in the at least one predetermined area includes increasing the thickness of the skin adjacent outer longitudinal edges of the core to provide a board having stiffer rails.

20. The method of claim 16, wherein the step of providing the core includes the steps of:
molding a precursor of the core; and
shaping the molded precursor of the core to form the core.
